(19) United States
(12) Patent Application Publication
(10) Pub. No.: US 2008/0247590 A1
(43) Pub. Date: Oct. 9, 2008

(54) STRUCTURE OF OVER-THE-EAR HOOK

(76) Inventor: Wen-Wei SUN, Taipei Hsien (TW)

Correspondence Address: RABIN & Berdo, PC, 1101 14TH STREET, NW, SUITE 500, WASHINGTON, DC, 20005, US

(21) Appl. No.: 11/695,934

(22) Filed: Apr. 3, 2007

(51) Int. Cl. H04R 25/02

(52) U.S. Cl. 381/381

(57) ABSTRACT

An over-the-ear hook is a one-piece tube that can hold an earphone for conducting sounds to the wearer's ear canal. The tube can be adjustable to the wearer's ear shape so as to allow the over-the-ear hook to rest securely behind any wearer's ear. To form an integral unit comprising the over-the-ear hook and the earphone: snugly ensconce the cable of said earphone in the groove cut in the surface of said tube as the opening of the groove is smaller than the diameter of said cable. The earphone can be easily detached from the over-the-ear hook after use for separate storage. Under the circumstances, the earphone cable needs not enlacing the over-the-ear hook for space-saving storage and would not be damaged thereof.

### BACKGROUND OF THE INVENTION

I. Field of the Invention

An over-the-ear hook is a tube that can hold an external earphone and bend to fit the wearer's ear shape so as to securely fit behind any wearer's ear. Moreover, it is a groove cut in the tube's surface that ensconces the cable of said earphone for holding said earphone in said tube.

II. Description of the Prior Art

The open-fit earphone 10 sold in the market that fits behind the ear is a one-piece earphone comprising an over-the-ear hook, a loudspeaker, which is protruded from one end of said over-the-ear hook for conducting sounds to the ear canal, and a cable, which is protruded from the other end of said over-the-ear hook for connecting to a player. With reference to FIG. 1, which is a three-dimensional view of an open-fit earphone of the prior art, the open-fit earphone 10 is a one-piece structure, which comprises a body 101, a cable 102 and a loudspeaker 103. The body 101 bends to fit behind the ear. The cable 102 is protruded from the body 101 for connecting to an external payer. The loudspeaker 103 fits in outer ear bowl to conduct sounds to the ear canal. The open-fit earphone replaces the headphone, which is fastened on the head with a hoop. However, the open-fit earphone 10 of the prior art is an one-piece structure that easily causes damage to its cable 102 as the cable would enlace its over-the-ear hook after use for a space-saving storage. The open-fit earphone of the prior art also exists in a structure that only comprises a loudspeaker and a cable, which is a loose line and can be easily hooked by other object to pull out said loudspeaker from outer ear bowl.

### SUMMARY OF THE INVENTION

In view of the drawbacks of the open-fit earphone of the prior art, the present invention aims at providing an innovative over-the-ear hook that can hold an external earphone and bend to fit the wearer's ear shape so as to securely fit behind the ear.

To achieve the foregoing objective, the over-the-ear hook of the present invention comprises a one-piece tube that can bend to fit the wearer's ear shape and comprises a groove cut in its surface so as to ensconce the cable of said earphone. Besides, the groove has an opening smaller than diameter of the earphone cable so that the earphone cable can snugly fit therein. The earphone can be easily detached from the over-the-ear hook after use for separate storage. Under the circumstances, the earphone cable needs not enlacing the over-the-ear hook for space-saving storage and would not be damaged thereof.

Desirable structure, assembly, and features of the present invention will be better understood from the detailed description and drawings that follow, in which various embodiments of the disclosed invention are illustrated by way of example.

### BRIEF DESCRIPTION OF THE DRAWINGS

FIG. 1 is a three-dimensional view of an open-fit earphone of the prior art.

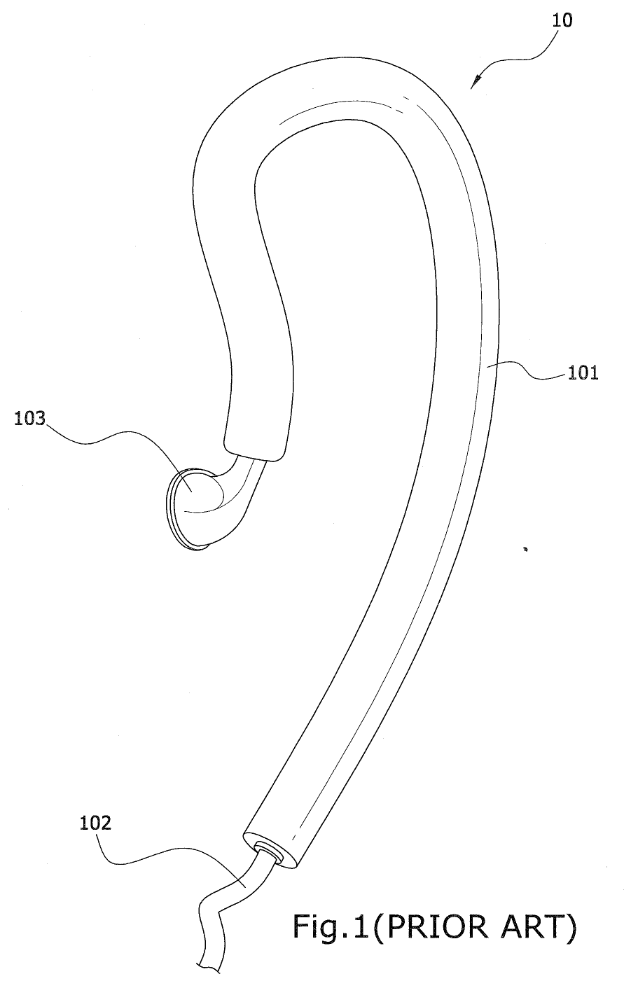

FIG. 2 is a three-dimensional view of the appearance of the invention.

FIG. 3 shows the embodiment of the invention.

### DESCRIPTION OF THE PREFERRED EMBODIMENTS

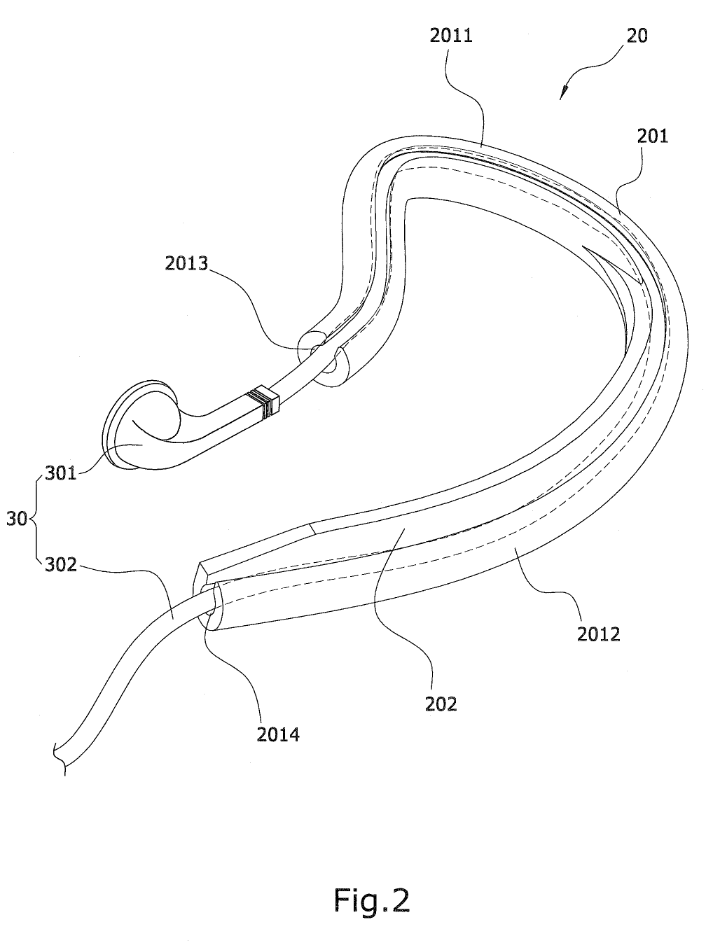

With reference to FIG. 2, which is a three-dimensional view of the appearance of the present invention, the over-the-ear hook 20 of the present invention is a one-piece tube 201 that can bend to perfectly fit the wearer's ear shape. The tube 201 comprises a crook portion 2011, a snug portion 2012 extended from said crook portion, a groove 202 cut in the tube's surface and two openings 2013/2014 formed respectively on the tube's two ends. An earphone 30, which comprises a cable 102 and a loudspeaker 103, can be held in the tube 201. The groove 202 is cut with an opening smaller than diameter of the cable 302 of the earphone 30, said cable 302 can thus snugly fit in. The loudspeaker 301 is protruded from the opening 2013 so as to fit in the wearer's outer ear bowl and the cable 302 from the opening 2014 so as to be connected to a player, which outputs sounds to the loudspeaker 301 at the other end.

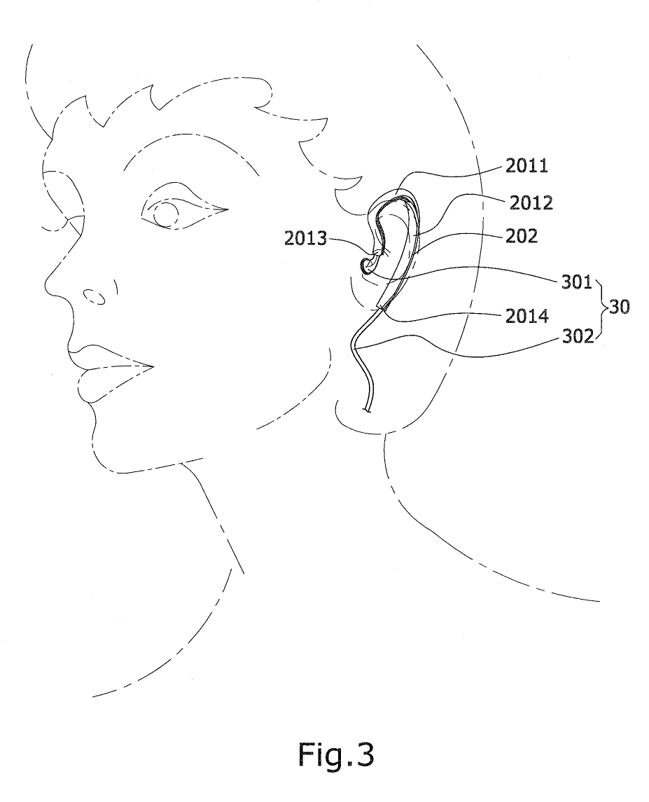

With reference to FIG. 3, which shows the embodiment of the present invention, the over-the-ear hook 20 is holding an external earphone 30. The embodiment mainly comprises a tube 201 that has a groove 202 cut in its surface. The external earphone 30 comprises a loudspeaker 301 and a cable 302. Fit the earphone 30 in the tube 201 by ensconcing the cable 302 in the groove 202 and making the loudspeaker 301 protruded from the opening 2013 of the tube 201. The earphone and the tube thus become an integral unit. This integral unit can perfectly fit behind the wearer's ear due to the crook portion 2011 and the snug portion 2012 of the over-the-ear hook. Moreover, being made of elastic material, the over-the-ear hook of the present invention can be easily adjustable to the wearer's ear shape. Consequently, the over-the-ear hook of the present invention would not press hard on the ear and provide comfortable wearing to any wearer. Furthermore, the cable 302 of the earphone 30 can be easily detached from the over-the-ear hook after use for a separate storage. Under the circumstances, the cable 302 needs not enlacing the over-the-ear hook for space-saving storage and would not be damaged thereof. Because the cable 302 ensconces in the tube 201, there is hardly any chance of pulling out the loudspeaker from outer ear bowl by a loosening cable 302 hooked by other object.

The foregoing embodiment demonstrates that the present invention holding an external earphone can perfectly fit the wearer's ear shape and securely rests behind the wearer's ear.

While the present invention is susceptible to various modifications and alternative forms, the specific embodiments have been shown by way of example in the drawings and described in detail herein. However, it should be understood that the present invention is not intended to be limited to the particular form disclosed. Rather, the present invention is to cover all modifications, equivalents, and alternatives falling within the spirit and scope of the present invention as defined by the appended claims.

To sum up, the over-the-ear hook of the present invention possesses the practicability and the advancement of the industry as it bends to fit the wearer's ear shape so as to securely rest behind the ear while holding an earphone.

What is claimed is:

1. An over-the-ear hook, which comprises:
a tube that is formed into a curved shape, comprising a crook portion on the upper section and a snug portion on the lower section;
a groove that is cut in the surface of said tube, with two openings that are formed on two ends of said tube.
